(19) United States
(12) Patent Application Publication
(10) Pub. No.: US 2002/0114967 A1
(43) Pub. Date: Aug. 22, 2002

(54) Release sheet and pressure-sensitive adhesive sheet containing the same

(75) Inventors: Hiraku Yamamoto, Osaka (JP); Shinji Inokuchi, Osaka (JP); Masayoshi Kawabe, Osaka (JP); Yoshio Oota, Osaka (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Nitto Denko Corporation, Ibaraki-shi (JP)

(21) Appl. No.: 10/007,493

(22) Filed: Nov. 13, 2001

(30) Foreign Application Priority Data
Nov. 15, 2000 (JP) 348622/2000

(51) Int. Cl. B32B 27/32; B32B 9/00

(52) U.S. Cl. 428/523; 428/41.3; 428/516

(57) ABSTRACT

The present invention provides a release sheet and a pressure-sensitive adhesive sheet superior to a release sheet using a conventional ethylene polymer in peeling property. Specifically, in an ethylene polymer to be used for a release sheet for a pressure-sensitive adhesive sheet, (i) the spin-spin relaxation time (T₂) of proton of the amorphous region and the ratio of the amorphous region calculated from the relaxation time (T₂) are adjusted to certain ranges, or (ii) the bearing ratios obtained by measuring the surface of a release sheet containing the ethylene polymer with an atomic force microscope is adjusted to a certain range.

### FIELD OF THE INVENTION

The present invention relates to a release sheet and a pressure-sensitive adhesive sheet containing the release sheet.

### BACKGROUND OF THE INVENTION

Pressure-sensitive adhesive sheets generally consist of a release sheet (also called a separator or a release liner), comprising a substrate (e.g., a plastic film, paper etc.) and a layer of release agent formed on the surface of the substrate, and a substrate having a pressure-sensitive adhesive layer. For use of a pressure-sensitive adhesive sheet, a release sheet is peeled off from a pressure-sensitive adhesive layer.

Release sheets for conventional pressure-sensitive adhesive sheets have been manufactured by applying a release agent to a surface that comes into contact with the pressure-sensitive adhesive layer and curing the agent. The release agent is exemplified by a silicone release agent that is superior in peeling property.

Conventional release sheets using a silicone release agent are superior in peeling property from a pressure-sensitive adhesive layer, but after peeling, a trace component of the silicone release agent in the release sheet attaches to the surface of the pressure-sensitive adhesive layer. A pressure-sensitive adhesive layer to which a silicone release agent is attached shows markedly degraded adhesion strength to an adhesion object, as compared to one without a silicone release agent.

The pressure-sensitive adhesive sheets are being used as a connecting material for the production of various precision electronic equipment (e.g., hard disc drive etc.). In such use, however, the components contained in the silicone release agent, which is attached to a pressure-sensitive adhesive layer upon peeling off of a release sheet from the pressure-sensitive adhesive layer, may cause corrosion of the inside of the electronic equipment or a malfunction of the electronic equipment. Consequently, there has arisen a tendency to avoid the use of a silicone release agent. It is therefore preferable that a release sheet to be used for a pressure-sensitive adhesive sheet for such use should not contain a silicone release agent.

In view of the above-mentioned problems associated with the use of a silicone release agent, various release sheets for a pressure-sensitive adhesive sheet without a silicone release agent have been proposed, such as release sheets containing various ethylene polymers (e.g., low density polyethylene etc.).

When a pressure-sensitive adhesive of conventional ethylene polymer release sheets shows comparatively high adhesion, however, the peeling strength of surface often becomes high (namely, hard to peel off), which restricts usable pressure-sensitive adhesives. Even if it can be peeled off, the peeling strength is still high and the sheet is not easy to use in practice. As such, conventional ethylene polymer release sheets are not entirely satisfactory from a practical aspect.

### SUMMARY OF THE INVENTION

The present invention aims at solving the above-mentioned problems in the release sheets using an ethylene polymer. Its object is to provide a release sheet superior in peeling property, which sheet shows suitably reduced peeling strength from the pressure-sensitive adhesive layer, as compared to a release sheet using a conventional ethylene polymer, and to provide a pressure-sensitive adhesive sheet using this release sheet.

According to the present invention, it has been found that, in an ethylene polymer contained in a release sheet,

(i) by adjusting the ratio of the amorphous region measured from the spin-spin relaxation time (T₂) of proton and the spin-spin relaxation time (T₂) of the amorphous region of ethylene polymer to certain ranges, or

(ii) by adjusting the bearing ratio obtained by measuring the surface of a release sheet containing the ethylene polymer with an atomic force microscope (also called AFM) to a certain range, a release sheet having a suitable peeling strength permitting practical use, wherein the peeling strength is considerably decreased as compared to a release sheet using conventional ethylene polymer (namely, superior in peeling property), can be obtained.

Accordingly, the present invention provides:

(1) a release sheet for a pressure-sensitive adhesive sheet, which release sheet having a monolayer structure or a laminate structure, wherein, when the release sheet has a monolayer structure, the release sheet itself, and when it has a laminate structure, a surface of at least one outermost layer of the release sheet, contains an ethylene polymer, and wherein the ethylene polymer shows both the following property values of a) and b):

a) spin-spin relaxation time (T₂) of proton in the amorphous region of the ethylene polymer of 130-350 μs at 30° C.,

b) a ratio of the amorphous region of the ethylene polymer, as calculated from the spin-spin relaxation time (T₂), of 7-17%,

(2) the release sheet of the above-mentioned (1), wherein the spin-spin relaxation time (T₂) of proton in the amorphous region of the aforementioned ethylene polymer is 170-280 μs at 30° C. and the ratio of the amorphous region of the ethylene polymer, as calculated from the spin-spin relaxation time (T₂), is 10-14%,

(3) the release sheet of the above-mentioned (1), wherein the aforementioned ethylene polymer is a copolymer of ethylene and a straight chain or branched chain α-olefin having 3 to 10 carbon atoms,

(4) the release sheet of the above-mentioned (3), wherein the aforementioned α-olefin is selected from the group consisting of 1-butene, 1-hexene and 1-octene,

(5) a pressure-sensitive adhesive sheet having the release sheet of the above-mentioned (1),

(6) a release sheet for a pressure-sensitive adhesive sheet, which release sheet having a monolayer structure or a laminate structure, wherein, when the release sheet has a monolayer structure, the release sheet itself, and when it has a laminate structure, a surface of at least one outermost layer of the release sheet, contains an ethylene polymer, and wherein a bearing ratio obtained by measuring the surface of the layer containing the ethylene polymer with an atomic force microscope is −30 to 15,

(7) the release sheet of the above-mentioned (6), wherein the aforementioned ethylene polymer is a copolymer of ethylene and a straight chain or branched chain α-olefin having 3 to 10 carbon atoms,

(8) the release sheet of the above-mentioned (7), wherein the aforementioned α-olefin is selected from the group consisting of 1-butene, 1-hexene and 1-octene, and

(9) a pressure-sensitive adhesive sheet having the release sheet of the above-mentioned (6).

### DETAILED DESCRIPTION OF THE INVENTION

The present invention is explained in detail in the following.

In the present specification, the term “sheet” includes sheet and tape. That is, the “release sheet” in the present specification encompasses release sheets and release tapes and the “pressure-sensitive adhesive sheet” encompasses pressure-sensitive adhesive sheets and pressure-sensitive adhesion tapes.

The release sheet for the pressure-sensitive adhesive sheet of the present invention has a monolayer structure or a laminate structure, wherein, when it has a monolayer structure, the release sheet itself, and when it has a laminate structure, a surface of at least one outermost layer of the release sheet contains an ethylene polymer having the particular properties to be mentioned below.

The ethylene polymer to be used in the present invention essentially has particular properties defined by the following (i) or (ii):

(i) spin-spin relaxation time (T₂) of proton in the amorphous region of the ethylene polymer is 130-350 μs at 30° C. and the ratio of the amorphous region of the ethylene polymer calculated from the spin-spin relaxation time (T₂) is 7-17%; and

(ii) the bearing ratio obtained by measuring the surface of the layer containing the ethylene polymer with an atomic force microscope is −30 to 15.

The above-mentioned properties (i) and (ii) are explained in the following.

Property (i)

In the present invention, the “spin-spin relaxation time (T₂) of proton” and “relaxation time (T₂)” means a spin-spin relaxation time (T₂) of proton measured with a pulse nuclear magnetic resonance spectrometer (hereinafter to be referred to as pulse NMR).

For the measurement of relaxation time (T₂) using the pulse NMR, various methods have been developed. In the present invention, a known solid-echo method has been employed as suitable method for measuring the relaxation time (T₂) of the crystalline region, amorphous region and the interface region between the crystalline region and the amorphous region of the polymer material.

When a polymer material is measured by a solid-echo method, 3 kinds of the relaxation time (T₂) corresponding to the crystalline region, amorphous region and the interface region between the crystalline region and the amorphous region of the polymer material can be obtained.

These relaxation times (T₂) depend on the motility of molecular chain of the polymer material. That is, the amorphous region having the greatest motility of molecular chain shows the longest relaxation time (T₂), the second longest relaxation time (T₂) in the interface region, and the shortest relaxation time (T₂) in the crystalline region wherein the motility of molecular chain is the lowest.

According to the solid-echo method, the number of protons present in the crystalline region, amorphous region and interface region of the polymer material can be calculated from these relaxation times (T₂). By inserting the number of protons into the following formula, the ratio of the protons present in the amorphous region of the polymer material, namely, the ratio of the amorphous region, can be calculated:

ratio of the amorphous region (%)={(the number of protons in the amorphous region)/[(the number of protons in the crystalline region)+(the number of protons in the amorphous region)+(the number of protons in the interface region)]}×100

The ratio of the amorphous region can be determined simultaneously with the measurement of the relaxation time (T₂) at pulse NMR.

The present inventors have found that the ratio of the amorphous region calculated according to the above-mentioned formula using the relaxation time (T₂) of the amorphous region of ethylene polymer used for the release sheet and the number of protons calculated from the relaxation time (T₂) influences the peeling property of the release sheet from a pressure-sensitive adhesive layer. Specifically, the present inventors have found that when the relaxation time (T₂) of the amorphous region of ethylene polymer is 130-350 μs, preferably 170-280 μs, at 30° C., at which the release sheet is put to practice, and from the respective numbers of protons at the crystalline region, interface region and amorphous region of the ethylene polymer, which are calculated from these relaxation times (T₂), when the ratio of the amorphous region calculated according to the above-mentioned formula is 7-17%, preferably 10-14%, a release sheet superior in peeling property can be obtained.

In the above-mentioned release sheet, when the relaxation time (T₂) of the amorphous region at 30° C. is less than 130 μs, the motility of molecular chain of the ethylene polymer of a release sheet surface on peeling is degraded, which in turn leads to difficulty in peeling of the release sheet from the pressure-sensitive adhesive layer, or the surface of the pressure-sensitive adhesive layer becomes undulate after peeling. When the relaxation time (T₂) is more than 350 μs, the motility of molecular chain of the ethylene polymer becomes too high and the heat resistance of the surface of the obtained release sheet is degraded, which is practically unpreferable.

When the ratio of the amorphous region of the above-mentioned ethylene polymer is less than 7%, the motility of molecular chain of the ethylene polymer of the release sheet surface on peeling is degraded, which in turn leads to a difficulty in peeling of the release sheet from the pressure-sensitive adhesive layer, or the surface of the pressure-sensitive adhesive layer becomes undulate after peeling. When the ratio of the amorphous region of the ethylene polymer becomes more than 17%, the release sheet becomes soft and loses self-supporting property, which is practically unpreferable.

Property of (ii)

According to the release sheet of the present invention, the bearing ratio when the surface (more specifically, near the surface) of the release sheet containing an ethylene polymer is measured with an atomic force microscope is −30 to 15, preferably −20 to 10.

In the release sheet of the present invention, the bearing ratio is determined as a level of changes in the distribution of surface roughness in the surface roughness of the release sheet containing an ethylene polymer surface by measuring surface roughness in the depth direction to the surface direction with an atomic force microscope and analyzing the distribution. To be specific, the target amplitude of cantilever of an atomic force microscope is set according to the tapping force of the cantilever to the sample surface, and the distribution of surface roughness in the depth direction to the surface direction of a sample surface is measured under the target amplitude set. Then, a bearing curve of the obtained distribution of surface roughness is determined under the target amplitude set. The bearing curve is a method widely used for statistical analysis of the distribution of surface roughness of the sample surface to the surface direction. By differencing the obtained bearing curves, the level of changes in surface roughness of the sample surface in the depth direction relative to the surface direction, namely, a bearing ratio, is obtained.

To set the peeling strength of the release sheet of the present invention from a pressure-sensitive adhesive layer within a preferable range, the bearing ratio of the surface of the release sheet containing an ethylene polymer is preferably within the range of −30 to 15. This is because, when the bearing ratio is within this range, changes in the surface roughness of the release sheet surface in the depth direction relative to the surface direction are small, and the crystallinity of the ethylene polymer in the vicinity of the surface of the release sheet is suitably low.

When the bearing ratio exceeds 15, the release sheet is difficult to peel from a pressure-sensitive adhesive layer, or the surface of the pressure-sensitive adhesive layer unpreferably becomes undulate after peeling. This is because, when the bearing ratio is within such range, the changes in the surface roughness of the release sheet surface in the depth direction relative to the surface direction are greater and the crystallinity in the vicinity of the surface of the release sheet is too high.

When the bearing ratio is less than −30, peeling requires an unpreferably greater force. This is considered to be attributable to greater irregularities derived from crystalline lamella slightly inside from the outermost surface of a release sheet than those of the outermost surface. This makes it difficult to pull out the polymer chain of the adhesive surface that intruded into the crystalline lamella by reptation from the pressure-sensitive adhesive layer toward the inside of the release sheet.

As used herein, being “superior in peeling property” and “having a suitable peeling strength” in the present specification mean that the peeling strength of a release sheet from a pressure-sensitive adhesive layer is 50 mN/50 mm-3000 mN/50 mm, preferably 100 mN/50 mm-2000 mN/50 mm. When the peeling strength exceeds 3000 mN/50 mm, peeling of the release sheet from the pressure-sensitive adhesive layer becomes difficult, making workability extremely low. When the peeling strength is smaller than 50 mN/50 mm, a release sheet does not sufficiently adhere to a pressure-sensitive adhesive layer, which may permit peeling during preservation and transportation, or unexpected peeling during actual application. As used herein, the unit of the peeling strength, “mN/50 mm”, is a value converted to the force per 50 mm width, which is necessary for peeling of release sheets having various widths, and does not intend to limit the width of the release sheet to 50 mm alone.

Release Sheet

The ethylene polymer to be used for the release sheet of the present invention may be any as long as it satisfies either the particular property (i) or (ii) defined in the above. Specific examples of the ethylene polymer include polyethylene consisting of ethylene monomer alone (homopolyethylene), and ethylene copolymer wherein ethylene and at least one monomer component (comonomer) other than ethylene are copolymerized.

When the above-mentioned ethylene polymer is used for a release sheet, the polymer chain of the adhesive layer surface easily invades into the inside by reptation from the surface of a release sheet upon adhesion to the adhesive layer. As a result, the adhesive layer and the release sheet are suitably adhered to each other, and the polymer chain of the adhesive layer surface is easily pulled out from the release sheet surface upon peeling. Based on this finding, the present inventors tested a number of ethylene polymers for the above-mentioned property (i) or (ii), and found that these properties can be a dependable parameter for controlling the peeling property of the release sheet.

The present inventors have found that, of ethylene polymers, particularly many copolymers of ethylene and α-olefin (namely, ethylene copolymers) have the properties of the present invention, and selected the following preferable ethylene copolymers for use in producing a release sheet. To be specific, as the comonomer to be copolymerized with ethylene to produce the ethylene polymer to be used in the present invention may be, for example, straight chain or branched chain α-olefin having 3 to 10, preferably 4 to 8, and more preferably 6 to 8, carbon atoms, which is generally propylene, butene, pentene, 4-methyl-1-pentene, hexene, heptene, octene and the like, preferably 1-butene, 1-hexene and 1-octene, and more preferably 1-hexene and 1-octene.

Examples of the ethylene polymer having the properties defined in the present invention include ethylene -1-hexene copolymer (manufactured by Japan Polyolefins Co., Ltd., J-REX LL AF204A), ethylene -1-octene copolymer (manufactured by Idemitsu Petrochemical Co., Ltd., MORETEC 0628D), ethylene -1-hexene copolymer (manufactured by Japan Polyolefins Co., Ltd., HARMOREX LL NH-745A) and the like.

The molecular chain structure of the above-mentioned ethylene polymer may have a straight chain or a branched chain. In view of easy selection of the material satisfying the above-mentioned property (i) or (ii) defined in the present invention, an ethylene polymer having a straight molecular chain is preferable.

When the above-mentioned ethylene polymer is used for the release sheet of the present invention, it may be used alone or in combination of two or more thereof, as long as it satisfies either the particular property (i) or (ii) defined in the present invention. Alternatively, it may be mixed with a resin other than ethylene polymer and/or additive before use, where necessary.

The release sheet of the present invention may have a monolayer structure or a laminate structure.

When the release sheet of the present invention has a monolayer structure, it is prepared by forming the above-mentioned ethylene polymer into a sheet according to a known molding method, such as extrusion molding, calendar molding, inflation molding and the like. The release sheet has a thickness that can be appropriately determined according to the use thereof. The thickness is generally 15 μm-300 μm, preferably 30 μm-200 μm and more preferably 50 μm-150 μm.

A release sheet having a laminate structure of the present invention can be obtained by laminating the above-mentioned ethylene polymer on a release sheet substrate at the side in contact with a pressure-sensitive adhesive layer or both sides thereof to form the outermost layer(s).

A release sheet having the above-mentioned laminate structure can be obtained by laminating an ethylene polymer by a known lamination method, such as extrusion lamination, dry lamination, wet lamination, hot melt lamination and the like, which comprises laminating on at least one side of a release sheet substrate. A release sheet having such laminate structure has a thickness determined as appropriate according to the use thereof. The thickness is generally 30 μm-300 μm, preferably 50 μm-200 μm, more preferably 70 μm-150 μm.

The material of the release sheet substrate to be used for a release sheet having the above-mentioned laminate structure maybe plastic, metal, paper and the like. Examples of the plastic to be used for the above-mentioned release sheet substrate include polyethylene (high density polyethylene, medium density polyethylene, low density polyethylene (e.g., straight chain low density polyethylene) etc.), polypropylene (e.g., isotactic polypropylene, syndiotactic polypropylene etc.), poly(4-methyl-1-pentene), polystyrene, polyvinyl chloride, polyester, nylon and the like. As the metal to be used for the above-mentioned release sheet substrate, aluminum, stainless, copper, zinc, gold, silver, nickel, chromium and the like can be mentioned. These may be used in the form of foil or may be used after vapor depositing on a different substrate. The paper to be used for the above-mentioned release sheet substrate is exemplified by Japanese paper, kraft paper, woodfree paper, crepe paper, glassine paper, clay-coated paper and the like.

Pressure-Sensitive Adhesive Layer

The pressure-sensitive adhesive sheet of the present invention is characterized in that it contains both a release sheet of the present invention and a pressure-sensitive adhesive layer.

The above-mentioned pressure-sensitive adhesive layer can be formed by applying a pressure-sensitive adhesive to be mentioned below to a surface of either the above-mentioned release sheet or the substrate, in the form of a solvent, emulsion or hot melt according to a known method and drying. The pressure-sensitive adhesive layer is formed to achieve a thickness after drying of 1 μm-70 μm, preferably 20 μm-50 μm.

Polyacrylic Ester Pressure-Sensitive Adhesive

Preferable examples of the above-mentioned pressure-sensitive adhesive include polyacrylic ester pressure-sensitive adhesives. The polyacrylic ester pressure-sensitive adhesive contains an acrylic ester polymer as a main component, which is obtained by polymerizing acrylic ester and/or methacrylic ester according to a polymerization method generally used by those of ordinary skill in the art, such as solution polymerization, emulsion polymerization, UV polymerization and the like.

More particularly, the above-mentioned acrylic ester polymer is a homopolymer obtained by polymerizing C₁-C₁₂ alkyl ester monomer of acrylic acid or methacrylic acid. Examples of the C₁-C₁₂ alkyl ester monomer of acrylic acid or methacrylic acid to be used for the homopolymer include ethyl (meth)acrylate, butyl (meth)acrylate, hexyl (meth)acrylate, octyl (meth)acrylate, 2-ethylhexyl (meth)acrylate, isooctyl (meth)acrylate, isononyl (meth)acrylate, decyl (meth)acrylate, dodecyl (meth)acrylate and the like, with preference given to ethyl (meth)acrylate, butyl (meth)acrylate, 2-ethylhexyl (meth)acrylate, isooctyl (meth)acrylate and isononyl (meth)acrylate, more preferably ethyl acrylate, butyl acrylate, 2-ethylhexyl acrylate, isooctyl acrylate and isononyl acrylate.

When a solvent is used for the polymerization of the above-mentioned acrylic ester polymer, toluene, ethyl acetate and the like are preferably -used as the solvent. Examples of the polymerization initiator include benzoyl peroxide, azobisisobutyronitrile and the like.

The obtained acrylic ester polymer preferably has a weight-average molecular weight of 150,000-1,200,000, more preferably 250,000-1,000,000.

The above-mentioned acrylic ester polymer may be a copolymer (acrylic ester copolymer) of the C₁-C₁₂ alkyl ester monomer of acrylic acid or methacrylic acid mentioned above and at least one member selected from the group of monomers for modification which are copolymerizable with this monomer (e.g., acrylic acid, methacrylic acid, 2-hydroxyethyl (meth)acrylate, 4-hydroxybutyl (meth)acrylate, 6-hydroxyhexyl (meth)acrylate, styrene and vinyl acetate).

The above-mentioned acrylic ester copolymer can be obtained by polymerization of the above-mentioned C₁-C₁₂ alkyl ester monomer of acrylic acid or methacrylic acid and the above-mentioned monomer for modification in the presence of a polymerization initiator such as benzoyl peroxide, azobisisobutyronitrile and the like in, where necessary, a solvent such as toluene, ethyl acetate and the like, when a solvent is used.

In the above-mentioned acrylic ester copolymer, the weight ratio of the C₁-C₁₂ alkyl ester monomer of acrylic acid or methacrylic acid and the monomer for modification charged for copolymerization is generally 100:1-90:15, preferably 100:3-90:10.

While the weight-average molecular weight of the above-mentioned acrylic ester copolymer is not particularly limited, it is generally 300,000-1,800,000, preferably 500,000-1,500,000, and more preferably 700,000-1,300,000.

A polyacrylic ester adhesive can be prepared by adding, where necessary, various additives to a polymer of acrylic ester alone or a copolymer obtained in the above. Examples of the additive include crosslinking agent, tackifier, softening agent, antioxidant, filler and the like.

A polyacrylic ester pressure-sensitive adhesive containing the above-mentioned acrylic ester homopolymer or copolymer is preferable, because the peeling property of the release sheet of the present invention from a pressure-sensitive adhesive layer can be further improved.

Polyester Pressure-Sensitive Adhesive

A pressure-sensitive adhesive preferable for the pressure-sensitive adhesive layer of the pressure-sensitive adhesive sheet of the present invention may be, for example, the aforementioned polyacrylic ester pressure-sensitive adhesive and polyester pressure-sensitive adhesive.

The above-mentioned polyester pressure-sensitive adhesive contains a polyester polymer obtained by polycondensation of aliphatic polyol and aliphatic or alicyclic polybasic acid. Particularly, a polyester polymer obtained by polycondensation of aliphatic polycarbonate diol and aliphatic or alicyclic polybasic acid is preferable as the aliphatic polyol.

As used herein, the “aliphatic polycarbonate diol” in the above-mentioned polyester polymer is diol containing an aliphatic carbonate residue of the following formula:

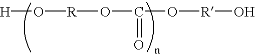

wherein R and R′ are each independently straight chain or branched chain hydrocarbon having 2 to 20 carbon atoms. In the above-mentioned formula, n is a number appropriately determined to make the weight-average molecular weight of the polyester polymer obtained by polycondensation of this aliphatic polycarbonate diol and a polybasic acid to be mentioned below fall within the range of 10,000-300,000, preferably 30,000-200,000.

As the aliphatic polyol other than the aforementioned aliphatic polycarbonate diol, straight chain diol is exemplified, such as ethylene glycol, propylene glycol, butanediol, pentanediol, hexanediol, heptanediol, octanediol, nonanediol, decanediol, octadecanediol and the like.

The aliphatic or alicyclic polybasic acid to be reacted with the above-mentioned aliphatic polyol preferably contains an aliphatic or alicyclic hydrocarbon group having 2 to 20 carbon atoms as a molecular backbone. This aliphatic hydrocarbon group may be a straight chain or a branched chain.

Examples of the aforementioned aliphatic or alicyclic polybasic acid include malonic acid, succinic acid, methyl succinic acid, adipic acid, sebacic acid, 1,2-dodecanoic diacid, 1,14-tetradecanoic diacid, n-hexyladipic acid, tetrahydrophthalic acid, endomethylenetetrahydrophthalic acid, and derivatives such as acid anhydrides, esters and acid halides (e.g., acid chloride etc.) thereof and the like.

The reaction between the above-mentioned aliphatic polyol and the above-mentioned aliphatic or alicyclic polybasic acid can be carried out according to a known method generally used for the synthesis of polyester, and the reaction gives a polyester polymer.

The above-mentioned polyester polymer has a weight-average molecular weight of generally 10,000-300,000, preferably 30,000-200,000.

The polyester pressure-sensitive adhesive containing the above-mentioned polyester polymer can be prepared by adding, where necessary, various additives to the polyester polymer obtained above. Examples of such additive include crosslinking agent, tackifier, softening agent, antioxidant, filler and the like.

The pressure-sensitive adhesive of the aforementioned polyacrylic ester and polyester in any form can be used for the preparation of the pressure-sensitive adhesive. It is preferable to use them in the form of a solvent, an emulsion or a hot melt for facilitated handling. The aforementioned pressure-sensitive adhesive can be used alone or two or more kinds thereof may be mixed, or mixed with other polymers by a known mixing or stirring method for use, as long as the pressure-sensitive adhesive sheet of the present invention does not have degraded adhesiveness.

Substrate

The pressure-sensitive adhesive sheet of the present invention has a substrate. This substrate is formed on the side opposite from the side of the pressure-sensitive adhesive layer that comes into contact with a release sheet. This substrate has a thickness of generally 10 μm-300 μm, preferably 50-200 μm.

As the material for the above-mentioned substrate, plastic, metal, paper and the like are used. Specific examples of the plastic to be used for the above-mentioned substrate include polyethylene (high density polyethylene, medium density polyethylene, low density polyethylene (e.g., straight chain low density polyethylene) etc.), polypropylene (e.g., isotactic polypropylene, syndiotactic polypropylene etc.), poly(4-methyl-1-pentene), polystyrene, polyvinyl chloride, polyester, nylon and the like. The metal to be used for the above-mentioned substrate may be, for example, aluminum, stainless steel, copper, zinc, gold, silver, nickel, chromium and the like, which may be used as foil, or may be vapor deposited on a different substrate for use. The paper to be used for the above-mentioned substrate is exemplified by Japanese paper, kraft paper, woodfree paper, crepe paper, glassine paper, clay-coated paper and the like.

The pressure-sensitive adhesive sheet of the present invention can be obtained by forming a pressure-sensitive adhesive layer by directly applying a pressure-sensitive adhesive to a release sheet and drying and adhering the substrate at the side opposite from the side of the pressure-sensitive adhesive layer that comes into contact with a release sheet.

Alternatively, the pressure-sensitive adhesive sheet of the present invention can be obtained by forming a pressure-sensitive adhesive layer on one side of a substrate and adhering a release sheet to the pressure-sensitive adhesive layer.

The pressure-sensitive adhesive sheet of the present invention may be a both surface type pressure-sensitive adhesive sheet having a pressure-sensitive adhesive layer and a release sheet on both sides of a substrate.

The pressure-sensitive adhesive sheet of the present invention may have a structure wherein a pressure-sensitive adhesive layer is in contact with one surface of a substrate and the outermost layer of the aforementioned release sheet is in contact with the other surface (back) of the substrate. A pressure-sensitive adhesive sheet having such structure is superior in peeling property from the backside.

The above-mentioned embodiments of the pressure-sensitive adhesive sheet of the present invention are also suitable when the present invention is a pressure-sensitive adhesive tape. When the present invention is a pressure-sensitive adhesive tape, it may be a pressure-sensitive adhesive tape of one side type or both side type, or a pressure-sensitive adhesive tape superior in peeling property from the backside.

### Examples

The present invention is explained in detail by referring to examples. The examples are mere exemplifications and do not limit the present invention in any way.

Measurement Method 1: Measurement Method of Spin-Spin Relaxation Time (T₂) of Proton of Ethylene Polymer and Evaluation Method of the Ratio of the Amorphous Region using the Relaxation Time (T₂)

Using pulse NMR (JNM-MU25A, manufactured by JEOL DATUM LTD.), the spin-spin relaxation time (T₂) of proton of the ethylene polymer used for release sheets in the following Examples and Comparative Examples was measured by a solid-echo method.

Measurement Conditions

Sample: the ethylene polymer used in Examples and Comparative Examples was cut into 1 mm x 10 mm, 100 μm thick strips and placed in a predetermined sample tube.

RF pulse width: 2.0 μS

RF pulse intervals: 8.0 μS

Pulse series repeat time: 2.0 S

Measurement temperature: 30° C.

To be specific, the above-mentioned relaxation time (T₂) is calculated by statistical processing, by the linear least square method, of the free induction decay signal obtained by measurement of the sample by the solid-echo method under the above-mentioned conditions. Weibull coefficient 1 or 2 was inserted as the coefficient in this case to calculate relaxation time (T₂) of the crystalline region, amorphous region and interface region of the ethylene polymer. From the obtained relaxation time (T₂), moreover, the number of protons in the crystalline region, the amorphous region and the interface region was calculated, and using the number of protons, the ratio of the amorphous region of the ethylene polymer relative to the entire region was calculate according to the following formula:

ratio of the amorphous region (%)={(the number of protons in the amorphous region)/[(the number of protons in the crystalline region)+(the number of protons in the amorphous region)+(the number of protons in the interface region)]}×100

Measurement Method 2: Evaluation Method of Bearing Ratio of Release Sheet Surface by Atomic Force Microscope

Using atomic force microscope Dimension 3000 (manufactured by Veeco Instruments Inc.), the bearing ratio of the release sheet surface used in the following Examples and Comparative Examples was measured. The cantilever of the atomic force microscope was for tapping mode and from single crystalline silicon, wherein cantilever length was 125 μm, force constant was 21.78 N/m and resonance frequency was 260-410 kHz. The measurement was performed at room temperature (23° C.) at a tapping mode. When the tapping force of a cantilever is weak, the target amplitude was set to 2V, and when the tapping force is strong, the target amplitude was set to 5V. Under these two target amplitude settings and in the vicinity of the surface of the release sheet, the distribution of surface roughness in the depth direction to the surface direction of the sample surface was measured for each. From the results of the distribution of surface roughness, a bearing curve widely used as a statistical analyze method of surface roughness was determined for each setting. By differencing the bearing curve at the target amplitude set to 2V from the bearing curve at the target amplitude set to 5V, the level of changes (bearing ratio) in the surface roughness in the depth direction to the surface direction of the sample surface was obtained.

Measurement Method 3: Peel Test

Each of the pressure-sensitive adhesive sheets prepared in the following Examples and Comparative Examples was cut into 2 samples having width 50 mm, length 150 mm, thickness 170 μm. The release sheet side of each sample was adhered to a rigid board and the substrate was peeled according to a known peel test method (1800 angle peel test) using a universal tensile tester (manufactured by Orientec Co. Ltd., RTM-100), whereby the peeling strength of each sample was measured. The measurement was performed in an atmosphere of temperature 23° C., 60% RH at the crosshead speed of the universal tensile tester of 300 mm/min.

### Example 1

(1-1) Preparation of Release Sheet

An ethylene 1-hexene copolymer (manufactured by Japan Polyolefins Co., Ltd., J-REX LL AF204A) was extruded from a 40φ single screw knead-extruder at an extrusion temperature of 200° C. to give a monolayer release sheet having a thickness of 100 μM.

(1-2) Preparation of Pressure-Sensitive Adhesive

n-Butyl acrylate (100 parts by weight) and acrylic acid (5 parts by weight) were polymerized in toluene (ca. 0.3 L relative to 1 kg in total of n-butyl acrylate and acrylic acid) in the presence of benzoyl peroxide (0.2 part by weight) as a polymerization initiator according to the solution polymerization method to give a toluene solution of polyacrylic copolymer having a weight-average molecular weight of 500,000 (prepared to solid content 30 wt %). A melamine crosslinking agent (1.5 parts by weight) and an isocyanate crosslinking agent (3 parts by weight) were added per this polyacrylic copolymer (100 parts by weight) to prepare a polyacrylic ester pressure-sensitive adhesive.

(1-3) Preparation of Pressure-Sensitive Adhesive Sheet

The polyacrylic ester pressure-sensitive adhesive obtained in the above-mentioned (1-2) was applied to one surface of a 25 μm thick polyester substrate with a bar coater so that the thickness after drying became 30 μm and dried at 120° C. for 3 min to give a substrate having a pressure-sensitive adhesive layer. The release sheet prepared in the above-mentioned (1-1) was adhered to the pressure-sensitive adhesive layer side of this substrate to give the pressure-sensitive adhesive sheet of the present invention.

### Example 2

In the same manner as in Example 1 except that an ethylene 1-octene copolymer (manufactured by Idemitsu Petrochemical Co., Ltd., MORETEC 0628D) was used as the ethylene polymer, a pressure-sensitive adhesive sheet was prepared.

### Example 3

In the same manner as in Example 1 except that an ethylene 1-hexene copolymer (manufactured by Japan Polyolefins Co., Ltd., HARMOREX LL NH-745A) was used as the ethylene polymer, a pressure-sensitive adhesive sheet was prepared.

### Comparative Example 1

In the same manner as in Example 1 except that an ethylene 1-octene copolymer (manufactured by the Dow Chemical Company, AFFINITY PL1850) was used as the ethylene polymer, a pressure-sensitive adhesive sheet was prepared.

### Comparative Example 2

In the same manner as in Example 1 except that an ethylene 1-octene copolymer (manufactured by the Dow Chemical Company, DOWLEX 2740E) was used as the ethylene polymer, a pressure-sensitive adhesive sheet was prepared.

### Comparative Example 3

In the same manner as in Example 1 except that an ethylene 1-hexene copolymer (manufactured by Japan Polyolefins Co., Ltd., HARMOREX LL NC-499A) was used as the ethylene polymer, a pressure-sensitive adhesive sheet was prepared.

The relaxation time (T₂) of the amorphous region, ratios of the amorphous region calculated from the relaxation time, bearing ratio and peeling strength used for a pressure-sensitive adhesive sheet, with regard to the release sheets of Examples 1-3 and Comparative Examples 1-3 are summarized in the following Table 1.

TABLE 1

| | Relaxation | | | |
|---|---|---|---|---|
| | time of | | | |
| | amorphous | Ratio of | | Peeling |
| | region | amorphous | Bearing | strength |
| | T₂ (μs) | region (%) | ratio | (mN/50 mm) |
| Example 1 | 257 | 10 | 13.2 | 830 |
| Example 2 | 221 | 10 | 5.3 | 550 |
| Example 3 | 201 | 12 | −17.1 | 1360 |
| Comparative | 167 | 18 | 16.2 | 4640 |
| Example 1 | | | | |
| Comparative | 189 | 2 | 28.0 | 6000 |
| Example 2 | | | | |
| Comparative | 128 | 4 | 15.1 | 5640 |
| Example 3 | | | | |

As is shown in Table 1, the pressure-sensitive adhesive sheets wherein the relaxation time (T₂) of the amorphous region of ethylene polymer contained in a release sheet and the ratio of the amorphous region calculated from this relaxation time (T₂) satisfy the particular ranges defined in the present invention, and the pressure-sensitive adhesive sheet wherein the bearing ratio of a surface of the release sheet satisfies the particular range defined in the present invention show noticeably decreased peeling strength to a preferable range (namely having superior peeling property), as compared to Comparative Examples using the ethylene polymers that failed to satisfy the above-mentioned property.

As is evident from the foregoing explanation, the present invention provides a release sheet superior in peeling property, as compared to a release sheet using conventional ethylene polymer, without using a silicone release agent for a release sheet, but by using (i) a release sheet for a pressure-sensitive adhesive sheet wherein the relaxation time (T₂) of the amorphous region of ethylene polymer contained in a release sheet and the ratio of the amorphous region calculated from this relaxation time (T₂) satisfy the particular ranges defined in the present invention, or (ii) a release sheet for a pressure-sensitive adhesive sheet wherein the bearing ratio of a surface of the release sheet satisfies the particular range defined in the present invention.

This application is based on patent application No. 2000-348622 filed in Japan, the contents of which are hereby incorporated by reference.

What is claimed is:

1. A release sheet for a pressure-sensitive adhesive sheet, which release sheet having a monolayer structure or a laminate structure, wherein, when the release sheet has a monolayer structure, the release sheet itself, and when it has a laminate structure, a surface of at least one outermost layer of the release sheet, comprises an ethylene polymer, and wherein the ethylene polymer shows both property values of a) and b):
a) spin-spin relaxation time (T₂) of proton in an amorphous region of the ethylene polymer of 130-350 μs at 30° C.,
b) a ratio of the amorphous region of the ethylene polymer, as calculated from the spin-spin relaxation time (T₂), of 7-17%.

2. The release sheet of claim 1, wherein the spin-spin relaxation time (T₂) of proton in the amorphous region of the ethylene polymer is 170-280 μs at 30° C. and the ratio of the amorphous region of the ethylene polymer, as calculated from the spin-spin relaxation time (T₂), is 10-14%.

3. The release sheet of claim 1, wherein the ethylene polymer is a copolymer of ethylene and a straight chain or branched chain α-olefin having 3 to 10 carbon atoms.

4. The release sheet of claim 3, wherein the α-olefin is selected from the group consisting of 1-butene, 1-hexene and 1-octene.

5. A pressure-sensitive adhesive sheet comprising the release sheet of claim 1.

6. A release sheet for a pressure-sensitive adhesive sheet, which release sheet having a monolayer structure or a laminate structure, wherein, when the release sheet has a monolayer structure, the release sheet itself, and when it has a laminate structure, a surface of at least one outermost layer of the release sheet, comprises an ethylene polymer, and wherein a bearing ratio obtained by measuring the surface of the layer comprising the ethylene polymer with an atomic force microscope is −30 to 15.

7. The release sheet of claim 6, wherein the ethylene polymer is a copolymer of ethylene and a straight chain or branched chain α-olefin having 3 to 10 carbon atoms.

8. The release sheet of claim 7, wherein the α-olefin is selected from the group consisting of 1-butene, 1-hexene and 1-octene.

9. A pressure-sensitive adhesive sheet comprising the release sheet of claim 6.
